(19) United States
(12) Patent Application Publication
(10) Pub. No.: US 2016/0190534 A1
(43) Pub. Date: Jun. 30, 2016

(54) SEPARATOR FOR LITHIUM ION SECONDARY BATTERY AND PREPARATION METHOD THEREOF

(71) Applicant: SAMSUNG ELECTRONICS CO., LTD., Suwon-si (KR)

(72) Inventors: Mitsuharu Kimura, Kanagawa (JP); Yoshitaka Yamaguchi, Kanagawa (JP)

(21) Appl. No.: 14/980,744

(22) Filed: Dec. 28, 2015

(30) Foreign Application Priority Data
Dec. 26, 2014 (JP) 2014-266063
Jul. 6, 2015 (JP) 2015-135542
Oct. 13, 2015 (KR) 10-2015-0143049

(51) Int. Cl. H01M 2/16; H01M 2/14; H01M 10/0525; H01M 12/08; H01M 10/052

(52) U.S. Cl. CPC H01M 2/1626; H01M 12/08; H01M 10/052; H01M 10/0525; H01M 2/145

(57) ABSTRACT

A separator for lithium ion secondary batteries that includes modified microfibrillated cellulose with carboxyl groups on a surface thereof, wherein counter ions of the carboxyl groups include lithium ions, the weight of metal ions other than lithium, in the counter ions, is 10 wt % or less with respect to a total weight of the lithium ions, and the separator has an average pore diameter of about 0.05 μm to about 1 μm.

### CROSS-REFERENCE TO RELATED APPLICATIONS

This application claims the benefit of Japanese Patent Application No. 2014-266063, filed on Dec. 26, 2014, and Japanese Patent Application No. 2015-135542, filed on Jul. 6, 2015, in the Japanese Patent Office, and Korean Patent Application No. 10-2015-0143049, filed on Oct. 13, 2015, in the Korean Intellectual Property Office, the disclosures of which are incorporated herein in their entireties by reference.

### BACKGROUND

1. Field

The present disclosure relates to separators for lithium ion secondary batteries and preparation methods thereof.

2. Description of the Related Art

Secondary batteries are widely used in mobile electronic devices, electric vehicles, hybrid vehicles, and the like. In particular, the development of lithium ion secondary batteries has been actively conducted due to their high energy density.

Currently, polyolefin-based microporous films are used as a separator for lithium ion secondary batteries due to low material costs, excellent mechanical characteristics, and chemical stability. However, these polyolefin-based microporous films have problems with heat resistance. To address such problems, coatings of ceramic particles, chemical crosslinking, and the like have been studied. However, such methods increase manufacturing costs.

Research into the use of materials with high heat resistance is underway. In particular, cellulose has attracted much attention due to being thermally stable up to about 300° C., renewable, and wood-derived.

However, when a general pulp is used as cellulose, it is difficult to fabricate a separator having a small thickness. To address this problem, a method using finely physically defibrated cellulose fibers (microfibrillated cellulose (MFC)) has been proposed (e.g., see Japanese Patent Application Laid-open No. 5445885).

Still, a uniform fiber diameter is difficult to obtain through defibration of cellulose fibers. Large-sized fibers are mixed into the cellulose fibers and, thus, large pores are formed. In addition, the number of points of contact formed by hydrogen bonding between cellulose fibers decreases and intensity is deteriorated.

Thus, to address these problems, a separator using cellulose fibers of a uniform length has been proposed. More particularly, a separator using microfibrillated cellulose having a uniform fiber diameter, obtained by using an N-oxyl compound and oxidizing cellulose having an I-type crystal structure, is disclosed (e.g., see Japanese Patent Application Publication No. 2013-251236).

However, in such a separator, when the surface of microcellulose is oxidized to carboxyl groups, counter ions are sodium ions, which hinder transfer of lithium ions when used in a lithium-ion battery. Also, water is used as a solvent in the process. In this regard, cellulose is dispersed in water to form a film and thus, during a drying process, cellulose is aggregated by hydrogen bonding to form a compact film and, consequently, satisfactory ion transfer (e.g., transfer of lithium ions) is hindered.

Thus, there remains a need for new separators for lithium ion batteries.

### SUMMARY

Provided are separators for lithium ion secondary batteries that exhibit satisfactory battery performance (e.g., cycle characteristics) without hindrance of transfer of lithium ions between electrodes.

According to an aspect of an exemplary embodiment, a separator for a lithium ion secondary battery includes modified microfibrillated cellulose with carboxyl groups on a surface thereof, wherein counter ions of the carboxyl groups include lithium ions, wherein, in the counter ions, a weight of metal ions other than lithium is 10 wt % or less with respect to a total weight of the lithium ions, and the separator has an average pore diameter of about 0.05 μm to about 1 μm.

According to an aspect of another exemplary embodiment, a lithium battery includes a positive electrode, a negative electrode, and the separator described above disposed between the positive electrode and the negative electrode.

According to an aspect of another exemplary embodiment, a method of manufacturing a separator for a lithium battery includes preparing a solution including modified microfibrillated cellulose with carboxyl groups on a surface thereof, a hydrophilic solvent having a boiling point of about 100 to about 160° C., and water, coating the solution on a substrate, drying the solution coated on the substrate to prepare a film, and separating the film from the substrate.

Additional aspects will be set forth in part in the description which follows and, in part, will be apparent from the description, or may be learned by practice of the presented exemplary embodiments.

### BRIEF DESCRIPTION OF THE DRAWINGS

These and/or other aspects will become apparent and more readily appreciated from the following description of the exemplary embodiments, taken in conjunction with the accompanying drawing in which:

FIG. 1 is a diagram of a lithium battery according to an exemplary embodiment.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present invention. As used herein, the term “and/or” includes any and all combinations of one or more of the associated listed items. Expressions such as “at least one of,” when preceding a list of elements, modify the entire list of elements and do not modify the individual elements of the list.

Hereinafter, separators for lithium ion secondary batteries according to exemplary embodiments and preparation methods thereof will be described in more detail.

A separator for lithium batteries according to an embodiment is formed by modified (that is, chemically treated) microfibrillated cellulose (cellulose nanofibers).

The separator is a separator for lithium batteries that includes modified microfibrillated cellulose having carboxyl groups on a surface thereof, and counter ions of the carboxyl groups include lithium ions. In the counter ions, the weight of metal ions other than lithium is 10 wt % or less with respect to a total weight of the lithium ions, and the separator has an average pore diameter of about 0.05 μm to about 1 μm.

Since the separator is formed of modified microfibrillated cellulose, heat resistance is increased, and lithium ion conductivity is enhanced since lithium ions are mainly included as counter ions of carboxyl groups, and an electrolyte including lithium ions easily flows due to the average pore diameter of from about 0.05 μm to about 1 μm.

Hereinafter, the separator for lithium batteries will be described in further detail.

(Modified Microfibrillated Cellulose)

In an embodiment, modified microfibrillated cellulose (MFC) is used as a material for forming the separator. As the MFC, cellulose having an I-type crystal structure in which a molecular chain (hydroxyl group) on a surface of the cellulose is oxidized to a carboxyl group by oxidation treatment is used. Thus, modified microfibrillated cellulose also can be referred to as surface-oxidized microfibrillated cellulose.

In an embodiment, natural cellulose having an I-type crystal structure is surface-treated by oxidation, thereby obtaining modified microfibrillated cellulose.

In addition, in an embodiment, oxidation treatment is performed using, for example, an N-oxyl compound (e.g., 2,2,6,6-tetramethylpiperidine-1-oxyl radical (hereinafter, referred to as “TEMPO”)).

Due to such oxidation treatment, it is possible to selectively oxidize only a crystal surface of cellulose fibers in a state in which a crystal structure thereof is maintained. Thereafter, defibration is performed, whereby a cellulose fiber in a minimum unit formed of highly crystalline natural cellulose may be obtained.

In addition, due to the I-type crystal structure, a decrease in intensity or dissolution of a cellulose fiber may be prevented.

The cellulose used as a raw material of the modified microfibrillated cellulose is not particularly limited. Examples of the natural cellulose may include, but are not particularly limited to, refined cellulose isolated from biosynthesis such as that of a plant, an animal, bacteria production gel, and the like, and examples of the natural cellulose may include, but are not limited to, coniferous wood pulp, deciduous wood pulp, cotton-based pulp such as cotton linter, non-wood-based pulp such as barley or bagasse pulp, bacteria cellulose, cellulose isolated from sea squirts, and cellulose isolated from seaweed.

In addition, the counter ions of the carboxyl groups of the modified microfibrillated cellulose may be an alkali metal ion such as lithium ion, sodium ion, or the like, an ammonium ion, or a quaternary ammonium ion. The counter ions of the carboxyl groups include lithium ions.

In addition, in an embodiment, the weight of metal ions other than lithium, in the counter ions, is 10 wt % or less with respect to a total weight of the lithium ions. For example, the weight of the metal ions other than lithium, in the counter ions, may be 8 wt % or less with respect to the total weight of the lithium ions. For example, the weight of the metal ions other than lithium, in the counter ions, may be 6 wt % or less with respect to the total weight of the lithium ions. For example, the weight of the metal ions other than lithium, in the counter ions, may be 4 wt % or less with respect to the total weight of the lithium ions. For example, the weight of the metal ions other than lithium, in the counter ions may be 2 wt % or less with respect to the total weight of the lithium ions. For example, the weight of the metal ions other than lithium, in the counter ions, may be 1 wt % or less with respect to the total weight of the lithium ions. In this regard, the limitation of the weight of the metal ion is due to, when the weight of the metal ions is greater than 10 wt %, transfer of lithium ions is hindered.

Therefore, most counter ions are lithium ions and, thus, it is possible to bind the lithium ions to the carboxyl groups of the modified microfibrillated cellulose. Thus, unlike a case in which counter ions are non-lithium ions (e.g., sodium ions), hindrance of transfer of lithium ions between electrodes is prevented. Consequently, satisfactory battery performance (e.g., cycle characteristics) may be achieved.

In addition, in an embodiment, the separator formed of the modified microfibrillated cellulose may have an average pore diameter of about 0.05 μm to about 1 μm. For example, the average pore diameter of the separator formed of the modified microfibrillated cellulose may be in the range of about 0.1 μm to about 1 μm. For example, the average pore diameter of the separator formed of the modified microfibrillated cellulose may be in the range of about 0.1 μm to about 0.8 μm. For example, the average pore diameter of the separator formed of the modified microfibrillated cellulose may be in the range of about 0.1 μm to about 0.6 μm. For example, the average pore diameter of the separator formed of the modified microfibrillated cellulose may be in the range of about 0.1 μm to about 0.5 μm. Due to such a configuration, pores of the separator through which lithium ions transfer may have a sufficiently large diameter. Thus, in a process of drying cellulose to obtain sheet-type cellulose, which will be described below, hindrance of transfer of lithium ions attributed to cellulose aggregation may be prevented. In particular, by setting the average pore diameter of the separator to 1 μm or less, occurrence of dendrite of lithium ions may be effectively prevented.

The term “average pore diameter” as used herein indicates a median diameter measured by a mercury porosity meter.

The content (amount) of the carboxyl groups of the modified microfibrillated cellulose may be, for example, about 0.1 to about 2.5 mmol/g, for example, about 0.3 to about 2.0 mmol/g, for example, about 0.5 to about 2.0 mmol/g. In this regard, when the amount of the carboxyl groups is less than about 0.1 mmol/g, electrostatic repulsion is decreased when defibration is performed and thus fibration properties may deteriorate. On the other hand, when the amount of the carboxyl groups is greater than 2.5 mmol/g, water solubility of cellulose may become too large.

In addition, the modified microfibrillated cellulose may have a number average fiber length of about 0.2 μm to about 3 μm, for example, about 0.5 μm to about 3 μm, for example, about 1 μm to about 3 μm. When the number average fiber length is less than 0.2 μm, the fibers have too small of a length and thus mechanical strength of the separator may be weak. On the other hand, when the number average fiber length is greater than 3 μm, the viscosity of a dispersion is too high and thus processability may be deteriorated.

The term “number average fiber length” as used herein indicates an average length of a plurality of fibers that is prepared by casting a modified microfibrillated cellulose dispersion on a substrate to a small thickness and drying the cast dispersion and, thereafter, is determined by observation using an atomic force microscope (AFM).

The number average fiber diameter of the modified microfibrillated cellulose may be about 100 nm or less. For example, the number average fiber diameter of the modified microfibrillated cellulose may be about 50 nm or less. For example, the number average fiber diameter of the modified microfibrillated cellulose may be about 20 nm or less. For example, the number average fiber diameter of the modified microfibrillated cellulose may be about 10 nm or less. For example, the number average fiber diameter of the modified microfibrillated cellulose may be about 5 nm or less. When the number average fiber diameter of the modified microfibrillated cellulose is greater than 100 nm, the separator may have a large pore diameter distribution.

In addition, the term “number average fiber diameter” as used herein indicates an average diameter of a plurality of fibers that is prepared by casting a modified microfibrillated cellulose dispersion on a substrate to a small thickness and drying the cast dispersion and, thereafter, is determined by observation using an atomic force microscope (AFM).

In addition, the separator may have a tensile strength of about 100 MPa to about 140 MPa. For example, the tensile strength of the separator may be in the range of about 100 MPa to about 130 MPa. For example, the tensile strength of the separator may be in the range of about 100 MPa to about 120 MPa. For example, the tensile strength of the separator may be in the range of about 100 MPa to about 110 MPa. When the tensile strength of the separator is within the ranges described above, excellent durability of the separator may be maintained and electrode expansion and the like may be effectively prevented. Measurement of the tensile strength will be described in more detail with reference to Evaluation Example 2 below.

The separator may have any physical form suitable for use in a lithium battery. Typically, the separator will be in the form of a sheet with a suitable thickness, for example, about 1˜100 μm, 5˜50 μm, or 10˜30 μm.

A lithium battery according to another embodiment includes a positive electrode, a negative anode, and the separator for lithium batteries described above that is disposed between the positive and negative electrodes. Since the lithium battery includes the separator, the lithium battery may have enhanced thermal resistance and excellent battery characteristics.

For example, the lithium battery may be a lithium ion battery.

The lithium ion battery may be manufactured using, for example, a method that will be described below.

First, a negative electrode is prepared.

For example, a negative active material composition, in which a negative active material, a conductive agent, a binder, and a solvent are mixed, is prepared. The negative active material composition is directly coated on a metal current collector to obtain a negative electrode plate. In another embodiment, the negative active material composition may be cast on a separate support and a film separated from the support may be laminated on a metal current collector to manufacture a negative electrode plate. The manufacture of the negative electrode is not limited to the above examples and may be performed using other methods.

The negative active material may be a non-carbonaceous material. For example, the negative active material may include at least one selected from the group consisting of a metal alloyable with lithium, an alloy of a metal alloyable with lithium, and an oxide of a metal alloyable with lithium.

For example, the metal alloyable with lithium may be silicon (Si), tin (Sn), aluminum (Al), germanium (Ge), lead (Pb), bismuth (Bi), antimony (Sb), a Si-yttrium (Y) alloy (Y is an alkali metal, an alkali earth metal, Group XIII to XVI elements, a transition metal, a rare earth element, or a combination thereof except for Si), a Sn—Y alloy (Y is an alkali metal, an alkali earth metal, Group XIII to XVI elements, a transition metal, a rare earth element, or a combination thereof except for Sn), or the like. Examples of Y may include magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), germanium (Ge), phosphorus (P), arsenic (As), antimony (Sb), bismuth (Bi), sulfur (S), selenium (Se), tellurium (Te), polonium (Po), and combinations thereof.

For example, the transition metal oxide may be lithium titanate oxide, vanadium oxide, lithium vanadium oxide, or the like.

For example, the non-transition metal oxide may be SnO₂ or SiOₓ where 0<x<2.

In particular, the negative active material may be at least one selected from the group consisting of Si, Sn, Pb, Ge, Al, SiOx where 0<x≦2 (e.g., x is an integer of 1 or 2), SnOy where 0<y≦2 (e.g., y is an integer of 1 or 2), Li₄Ti₅O₁₂, TiO₂, LiTiO₃, and Li₂Ti₃O₇. In this regard, the negative active material is not particularly limited to the above examples and any negative active material used in the art as a non-carbonaceous negative active material may be used.

In addition, the negative active material may be a composite of the non-carbonaceous negative active material and a carbonaceous material and may further include a carbonaceous negative active material in addition to the non-carbonaceous material.

The carbonaceous material may be crystalline carbon, amorphous carbon, or a mixture thereof. Examples of the crystalline carbon include natural graphite and artificial graphite, each of which has an irregular form or is in the form of a plate, a flake, a sphere, or a fiber. Examples of the amorphous carbon include, but are not limited to, soft carbon (low-temperature calcined carbon), hard carbon, mesophase pitch carbide, and calcined coke.

The conductive agent may be natural graphite, artificial graphite, carbon black, acetylene black, ketjen black, carbon fiber, metal powder or fiber of copper, nickel, aluminum, or silver, or the like. In addition, conductive materials such as polyphenylene derivatives and the like may be used alone or at least one selected therefrom may be used. However, the conductive agent is not limited to the above examples and any conductive agent used in the art may be used. In addition, the crystalline carbonaceous material described above may be added as a conductive agent.

Examples of the binder include a vinylidene fluoride/hexafluoropropylene copolymer, polyvinylidene fluoride (PVDF), polyacrylonitrile, polymethylmethacrylate, polytetrafluoroethylene (PTEE), a mixture of the aforementioned polymers, and a styrene butadiene rubber-based polymer. However, the binder is not particularly limited to the above examples and may be any binder that is commonly used in the art.

The solvent may be N-methylpyrrolidone, acetone, water, or the like. However, the solvent is not particularly limited to the above examples and may be any solvent that is commonly used in the art.

The amounts of the negative active material, the conductive agent, the binder, and the solvent may be the same level as those used in a general lithium battery. At least one of the conductive agent, the binder, and the solvent may not be used according to the use and constitution of desired lithium batteries.

Next, a positive electrode is prepared.

For example, a positive active material composition, in which a positive active material, a conductive agent, a binder, and a solvent are mixed, is prepared. The positive active material composition is directly coated on a metal current collector and dried to obtain a positive electrode. In another embodiment, the positive active material composition may be cast on a separate support and a film separated from the support may be laminated on a metal current collector to complete fabrication of a positive electrode plate.

The positive active material may be at least one selected from the group consisting of a lithium cobalt oxide, a lithium nickel cobalt aluminum oxide, a lithium iron phosphorus oxide, and a lithium manganese oxide. However, the positive active material is not particularly limited to the above examples and any positive active material used in the art may be used.

For example, the positive active material may be a compound represented by any one of Formulae: LiₐA_{1-b}B_{b}D₂ where 0.90≦a≦1.8 and 0≦b≦0.5; LiₐE_{1-b}B_{b}O_{2-c}D_{c} where 0.90≦a≦1.8, 0≦b≦0.5, and 0≦c≦0.05; LiE_{2-b}B_{b}O_{4-c}D_{c} where 0≦b≦0.5 and 0≦c≦0.05; LiₐNi_{1-b-c}Co_{b}B_{c}D_{α} where 0.90≦a≦1.8, 0≦b≦0.5, 0≦c≦0.05, and 0<α≦2; LiₐNi_{1-b-c}Co_{b}B_{c}O_{2-α}F_{α} where 0.90≦a≦1.8, 0≦b≦0.5, 0≦c≦0.05, and 0<α<2; LiₐNi_{1-b-c}Co_{b}B_{c}O_{2-α}F₂ where 0.90≦a≦1.8, 0≦b≦0.5, 0≦c≦0.05, and 0<α<2; LiₐNi_{1-b-c}Mn_{b}B_{c}D_{α} where 0.90≦a≦1.8, 0≦b≦0.5, 0≦c≦0.05, and 0<α≦2; LiₐNi_{1-b-c}Mn_{b}B_{c}O_{2-α}Fₐ where 0.90≦a≦1.8, 0≦b≦0.5, 0≦c≦0.05, and 0<α<2; LiₐNi_{1-b-c}Mn_{b}B_{c}O_{2-α}F₂ where 0.90≦a≦1.8, 0≦b≦0.5, 0≦c≦0.05, and 0<α<2; LiₐNi_{b}E_{c}G_{d}O₂ where 0.90≦a≦1.8, 0≦b≦0.9, 0≦c≦0.5, and 0.001≦d≦0.1; LiₐNi_{b}Co_{c}Mn_{d}GeO₂ where 0.90≦a≦1.8, 0≦b≦0.9, 0≦c≦0.5, 0≦d≦0.5, and 0.001≦e≦0.1; LiₐNiG_{b}O₂ where 0.90≦a≦1.8 and 0.001≦b≦0.1; LiₐCoG_{b}O₂ wherein 0.90≦a≦1.8 and 0.001≦b≦0.1; LiₐMnG_{b}O₂ where 0.90≦a≦1.8 and 0.001≦b≦0.1; LiₐMn₂G_{b}O₄ where 0.90≦a≦1.8 and 0.001≦b≦0.1; QO₂; QS₂; LiQS₂; V₂O₅; LiV₂O₅; LiIO₂; LiNiVO₄; Li_{(3-f)}J₂(PO₄)₃ where 0≦f≦2; Li_{(3-f)}Fe₂(PO₄)₃ where 0≦f≦2; and LiFePO₄.

In the formulae above, A is Ni, Co, Mn, or a combination thereof, B is Al, Ni, Co, Mn, Cr, Fe, Mg, Sr, V, a rare earth element, or a combination thereof, D is O, F, S, P, or a combination thereof, E is Co, Mn, or a combination thereof, F is F, S, P, or a combination thereof, G is Al, Cr, Mn, Fe, Mg, La, Ce, Sr, V, or a combination thereof, Q is Ti, Mo, Mn, or a combination thereof, I is Cr, V, Fe, Sc, Y, or a combination thereof, and J is V, Cr, Mn, Co, Ni, Cu, or a combination thereof.

In addition, the compounds described above may have a coating layer at their surfaces. In another embodiment, the compounds may be used in combination with a compound having a coating layer. The coating layer may include a coating element compound, such as an oxide of a coating element, a hydroxide of a coating element, an oxyhydroxide of a coating element, an oxycarbonate of a coating element, or a hydroxycarbonate of a coating element. The coating element compounds may be amorphous or crystalline. The coating element included in the coating layer may be Mg, Al, Co, K, Na, Ca, Si, Ti, V, Sn, Ge, Ga, B, As, Zr, or a mixture thereof. A coating layer may be formed by using the coating elements in the aforementioned compounds by using any one of various methods that do not adversely affect physical properties of a positive active material (e.g., spray coating, immersion, or the like). The coating layer formation methods may be obvious to one of ordinary skill in the art and thus will not be described in detail.

Examples of the positive active material include LiNiO₂, LiCoO₂, LiMnₓO₂ₓ where x=1 or 2, LiNi₁₋ₓMnₓO₂ where 0<x<1, LiNi_{1-x-y}CoₓMn_{y}O₂ where 0≦x≦0.5 and 0≦y≦0.5, LiFeO₂, V₂O₅, TiS, and MoS.

In the positive active material composition, a conductive agent, a binder, and a solvent that are the same as those used in the negative active material composition may be used. In addition, pores may be formed in an electrode plate by further adding a plasticizer to the positive active material composition and/or the negative active material composition.

The amounts of the positive active material, a conductive agent, and a general binder are the same level as those used in a general lithium battery. At least one of the conductive agent, the binder, and the solvent may not be used according to the use and constitution of desired lithium batteries.

Next, the separator described above is disposed between the positive electrode and the negative electrode.

The separator is a separator for lithium batteries that includes the modified microfibrillated cellulose described above with carboxyl groups on a surface thereof, and counter ions of the carboxyl groups include lithium ions. In the counter ions, the weight of metal ions other than lithium is 10 wt % or less with respect to a total weight of the lithium ions, and an average pore diameter of the separator is in the range of about 0.05 μm to about 1 μm. All other aspects of the separator are as previously described herein.

Next, an electrolyte is prepared. The electrolyte may be in a liquid or gel state.

For example, the electrolyte may be an organic electrolytic solution.

The organic electrolytic solution may be prepared by dissolving a lithium salt in an organic solvent.

Any organic solvent that may be commonly used in the art may be used. Examples of the organic solvent include propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, dimethyl ether, and mixtures thereof.

Any lithium salt that is commonly used in the art may be used. For example, the lithium salt may be LiPF₆, LiBF₄, LiSbF₆, LiAsF₆, LiCIO₄, LiCF₃SO₃, Li(CF₃SO₂)₂N, LiC₄F₉SO₃, LiAIO₂, LiAlCl₄, LiN(CₓF₂ₓ₊₁SO₂)(C_{y}F_{2y+1} SO₂) where x and y are independently a natural number, LiCl, LiI, or a mixture thereof.

In another embodiment, the electrolyte may be in a solid form. Examples of the electrolyte include boron oxides, lithium oxynitride, and the like. However, the electrolyte is not limited to the above examples, and may be any solid electrolyte used in the art. The solid electrolyte may be formed on the negative electrode by sputtering or the like.

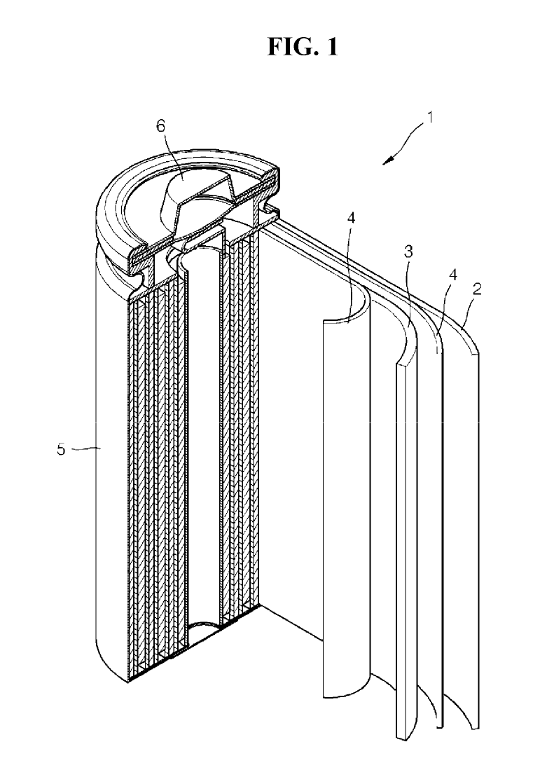

Lastly, the electrolytic solution is injected between the positive electrode and the negative electrode and the separator disposed therebetween, thereby completing manufacture of the lithium ion battery. As illustrated in FIG. 1, for example, a lithium battery 1 includes a positive electrode 3, a negative electrode 2, and a separator 4. The positive electrode 3, the negative electrode 2, and the separator 4 are wound or folded and, thereafter, accommodated in a battery case 5. Subsequently, an organic electrolytic solution is injected into the battery case 5 and the battery case 5 is sealed with a cap assembly 6, thereby completing fabrication of the lithium battery 1. The battery case 5 may have a cylindrical, rectangular or thin film shape. For example, the lithium battery may be a thin film-type battery. For example, the lithium battery 1 may be a lithium ion polymer battery.

The separator may be disposed between the positive electrode and the negative electrode to form a battery assembly. A plurality of battery assemblies may be stacked in a bi-cell structure and impregnated into an organic electrolytic solution. The resultant is put into a pouch and hermetically sealed, thereby completing the manufacture of the lithium ion polymer battery.

In addition, the battery assemblies are stacked to form a battery pack, and such a battery pack may be used in any devices requiring high capacity and high-power output. For example, the battery pack may be used in notebook computers, smart phones, or electric vehicles.

In particular, the lithium battery has excellent thermal stability and satisfactory battery characteristics and thus is suitable for use in electric vehicles (EVs). For example, the lithium battery may be used in hybrid vehicles such as a plug-in hybrid electric vehicle (PHEV) or the like.

In another embodiment, the lithium battery may be a lithium air battery.

For example, the lithium air battery may be prepared as follows.

First, an air electrode is prepared as a positive electrode. For example, the air electrode may be fabricated as follows. The electrode member may be manufactured by mixing a conductive material and a binder with or without a suitable solvent to prepare an air electrode slurry, coating the air electrode slurry on a surface of a current collector and drying the coated current collector and, selectively, performing compression molding on the current collector to enhance electrode density. The current collector may be a gas diffusion layer. In another embodiment, the electrode member may be manufactured by coating the air electrode slurry on a surface of a separator or a solid electrolyte membrane and drying the coated member and, selectively, performing compression molding on a separator or a solid electrolyte membrane to enhance electrode density.

A conductive material included in the air electrode slurry may be porous. Thus, any conductive material with porosity and conductivity may be used without any particular limitation and may be, for example, a carbonaceous material with porosity may be used. Examples of the carbonaceous material may include carbon blacks, graphites, graphenes, activated carbons, and carbon fibers.

A catalyst for oxidation/reduction of oxygen may be added to the air electrode slurry. Examples of the catalyst include, but are not limited to, precious metal-based catalysts such as platinum, gold, silver, palladium, ruthenium, rhodium, and osmium; oxide-based catalysts such as a manganese oxide, an iron oxide, a cobalt oxide, and a nickel oxide; and an organic metal-based catalyst such as cobalt phthalocyanine. However, the catalyst is not particularly limited to the above examples and any catalyst for oxidation/reduction of oxygen used in the art may be used.

In addition, the catalyst may be supported on a catalyst support. The catalyst support may be oxide, zeolite, clay-based mineral, carbon, or the like. The oxide may include at least one oxide of alumina, silica, zirconium oxide, and titanium dioxide. The oxide may be an oxide including at least one metal selected from cerium (Ce), praseodymium (Pr), samarium (Sm), europium (Eu), terbium (Tb), thulium (Tm), ytterbium (Yb), antimony (Sb), bismuth (Bi), vanadium (V), chromium (Cr), manganese (Mn), iron (Fe), cobalt (Co), nickel (Ni), copper (Cu), niobium (Nb), molybdenum (Mo), and tungsten (W). Examples of the carbon include carbon blacks such as Ketjen black, acetylene black, channel black, and lamp black; graphites such as natural graphite, artificial black, and expandable graphite; activated carbons; and carbon fibers. However, the carbon is not limited to the above examples, and, for example, any catalyst support used in the art may be used.

The air electrode slurry may include a binder. The binder may include a thermo-plastic resin or a thermosetting resin. Examples of the binder include polyethylene, polypropylene, polytetrafluoro ethylene (PTFE), polyvinylidene fluoride (PVDF), styrene-butadiene rubber, a tetrafluoroethylene-perfluoroalkylvinylether copolymer, a vinylidene fluoride-hexafluoropropylene copolymer, a vinylidene fluoride-chlorotrifluoroethylene copolymer, an ethylene-tetrafluoroethylene copolymer, polychlorotrifluoroethylene, a vinylidene fluoride-pentafluoropropylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethylvinylether-tetrafluoroethylene copolymer, and an ethylene-acrylic acid copolymer. In this regard, the binder may be used alone or in combination. However, the binder is not limited to the above examples, and any binder used in the art may be used.

To rapidly diffuse oxygen, the current collector may be a porous structure in a net or mesh form or a porous metal plate formed of stainless steel, nickel, aluminum, or the like. However, the current collector is not limited to the above examples, and any current collector used in the art may be used. The current collector may be coated with an oxidation resistant metal or alloy in order to prevent the current collector from being oxidized.

The air electrode slurry may selectively include a general catalyst for oxidation/reduction of oxygen and a general conductive material. In addition, the air electrode slurry may selectively include lithium oxide.

Next, a negative electrode is prepared.

The negative electrode may be, for example, a lithium metal thin film. A lithium metal-based alloy may be, for example, an alloy of lithium and aluminum, tin, magnesium, indium, calcium, titanium, vanadium, or the like.

Next, the separator for lithium batteries described above is disposed between the air electrode and the negative electrode.

The separator is a separator for lithium batteries that includes the modified microfibrillated cellulose described above with carboxyl groups on a surface thereof, and counter ions of the carboxyl groups include lithium ions. In the counter ions, the weight of metal ions other than lithium is 10 wt % or less with respect to a total weight of the lithium ions, and an average pore diameter of the separator is in the range of about 0.05 μm to about 1 μm.

In addition, another separator in addition to the modified microfibrillated cellulose described above as a separator may be further disposed. The further disposed separator is not particularly limited as long as it has high endurance during lithium air battery operations. For example, the separator may be a porous film formed of a polymer non-fabric such as polypropylene or polyphenylene sulfide non-fabric, or an olefin-based resin such as polyethylene, polypropylene, or the like. In this regard, at least two of these materials may be used in combination.

In addition to the separator, an oxygen blocking film that is impervious to oxygen may further be disposed between the air electrode and the negative electrode. The oxygen blocking film may be a lithium ion conductive solid electrolyte membrane and serve as a protective film that prevents impurities such as oxygen and the like included in the air electrode from directly reacting with the negative electrode formed of lithium metal. A material for forming the lithium ion conductive solid electrolyte membrane impervious to oxygen may be lithium ion conductive glass, lithium ion conductive crystals (ceramic or glass-ceramic), or an inorganic material containing a mixture thereof. However, the material is not particularly limited to the above examples and any solid electrolyte membrane used in the art that has lithium ion conductivity, is impervious to oxygen and protects a negative electrode may be used. Tacking chemical stability of the lithium ion conductive solid electrolyte membrane into consideration, the lithium ion conductive solid electrolyte membrane may include an oxide.

Examples of the lithium ion conductive crystals include Perovskite crystals with lithium ion conductivity, such as Li₃N, LISICONs, and La_{0.55}Li_{0.35}TiO₃, LiTi₂P₃O₁₂ crystals having a NASICON structure, and glass-ceramic that deposits these crystals.

Examples of the lithium ion conductive crystals include, but are not limited to, lithium-aluminum-germanium-phosphate (LAGP), lithium-aluminum-titanium-phosphate (LATP), and lithium-aluminum-titanium-silicon-phosphate (LATSP).

For example, an oxygen blocking film including lithium ion conductive crystals may be a solid electrolyte membrane including Li_{1+x+y}Alₓ(Ti,Ge)₂₋ₓSi_{y}P_{3-y}O₁ where 0≦x≦1 and 0≦y≦1, for example, LATP(Li_{1.4}Ti_{1.6}Al_{0.4}P₃O₁₂).

Next, an electrolyte is injected into the air electrode and the negative electrode. The electrolyte may be the same as that used in the lithium ion battery. The electrolyte may be impregnated in the separator and the positive electrode (air electrode).

The shape of the lithium air battery is not particularly limited. Examples of the shape include a coin-shape, a button-shape, a sheet-shape, a stack-type, a cylinder-shape, a panel-shape, and a corn-shape. Also, the lithium air battery may be used in a large-size battery for electric vehicles.

The term “air” used herein is not limited to atmospheric air, and refers to either a gas combination including oxygen or a pure oxygen gas. The broad definition of the term “air” may be applied to all kinds of applications including an air battery, an air cathode, and the like.

Thus, provided herein is a lithium battery comprising the separator, which batter can have any of the attributes described with respect to the method of preparing a lithium battery.

A method of manufacturing a separator for lithium batteries, according to another embodiment, will now be described.

The method includes modifying cellulose, refining the modified cellulose, dispersing the refined cellulose in a dispersion medium to perform microfibrillation, and drying the microfibrillated cellulose to form sheet-type cellulose nanofibers.

The method includes: preparing a solution including a modified microfibrillated cellulose with carboxyl groups on a surface thereof, a hydrophilic solvent having a boiling point of about 100° C. to about 160° C., and water; coating the solution on a substrate; drying the solution coated on the substrate to prepare a film; and separating the film from the substrate. The solution may be a dispersion.

In the preparation method, a pore size of the separator may be easily adjusted by using a solution including both water and a hydrophilic solvent having a temperature within a predetermined range.

(Cellulose Modification Process)

First, a surface of a natural cellulose fiber having an I-type crystal structure is oxidation-treated, thereby oxidizing molecular chains (hydroxyl groups) of cellulose to carboxyl groups, to modify the cellulose fiber.

More particularly, in an embodiment, a modified cellulose fiber is prepared by oxidation using 2,2,6,6-tetramethylpiperidine-1-oxyl (TEMPO) under alkali conditions.

This method is performed by, first, suspending a bleached coniferous pulp in water and adding TEMPO and sodium bromide (NaBr) to the suspended water. Subsequently, a small amount of an aqueous sodium hypochlorite solution is added to the resulting solution to initiate an oxidation reaction.

During the oxidation reaction, an aqueous sodium hydroxide (NaOH) solution having a predetermined concentration is added dropwise to the resulting solution and pH thereof is maintained to a predetermined value. In this regard, the reaction is terminated at a time when there is no change in pH, thereby obtaining a modified cellulose fiber.

For example, the amount of the carboxyl groups in the obtained modified cellulose fiber may be in the range of about 0.1 mmol/g to about 2.5 mmol/g.

For example, the obtained modified cellulose fiber may have a number average fiber length of about 0.2 μm to about 3 μm.

For example, the obtained modified cellulose fiber may have a number average fiber diameter of 100 nm or less.

(Cellulose Refinement Process)

Until pH is stabilized after the oxidation reaction is terminated, an acid (e.g., hydrochloric acid) with a predetermined concentration is added dropwise by stirring. Subsequently, filtration and washing using pure water are performed and repeated until pH of the pure water used in the washing process becomes the same as pH of the solution obtained from the washing process of filtered modified cellulose fiber.

Subsequently, neutralization is performed by adding, to a solution including the obtained modified cellulose fiber, an aqueous alkali solution (e.g., an aqueous lithium hydroxide solution) including pure water and a predetermined concentration of lithium ions until pH reaches a predetermined value, to refine the modified cellulose fiber and, at the same time, prepare a suspension of the modified cellulose fiber with a predetermined concentration.

In this regard, by neutralizing the solution including the modified cellulose fiber by using an aqueous alkali solution (e.g., an aqueous lithium hydroxide solution) including lithium ions, counter ions of carboxyl groups on the surface of the modified cellulose fiber may be converted to lithium ions.

Due to such conversion into lithium ions, the weight of metal ions other than lithium, in the counter ions, may be 10 wt % or less with respect to a total weight of the lithium ions.

(Cellulose Microfibrillation (Dispersion) Process)

Next, the suspension of the modified cellulose fiber is treated using a dispersing device (e.g., high-pressure homogenizer) predetermined times, a dispersion medium is added to the resulting suspension, and the resulting solution is sufficiently stirred, thereby obtain a dispersion of modified microfibrillated cellulose (modified cellulose nanofibers).

The dispersion process may be performed using a well-known dispersing device, for example, a propeller type mixer, a paddle type mixer, a dispersion type mixer, a turbine type mixer, or the like. In addition, a dispersion of finer nanofibers may be obtained using a device having a strong beating ability such as a homomixer at high-speed rotation, a high pressure homogenizer, an ultrasonic dispersion treatment device, a beater, a disk type refiner, a conical type refiner, a double-disk type refiner, a grinder, or the like.

In addition, as the dispersion, a dispersion including the modified microfibrillated cellulose and a hydrophilic solvent having a boiling point of about 100° C. to about 160° C. in amounts of about 0.1 to about 10 wt % and about 1 to about 50 wt %, respectively, with respect to a total amount of the dispersion is used.

In this regard, such a limitation of the modified microfibrillated cellulose to about 0.1 wt % to about 10 wt % is due to, when the amount of the modified microfibrillated cellulose is less than 0.1 wt %, the amount of solids is too small and thus a large amount of time is needed for drying, which leads to an increase in preparation costs. In addition, when the amount of the modified microfibrillated cellulose is greater than 10 wt %, the viscosity of the dispersion is too high and thus processability may be deteriorated.

In addition, such a limitation of the hydrophilic solvent to about 1 wt % to about 50 wt % is due to, when the amount of the hydrophilic solvent is less than 1 wt %, the amount of the solvent contributing to control the pore diameter of the separator is too small and thus cellulose fibers may be aggregated by hydrogen bonds of surfaces of the cellulose fibers. In addition, when the amount of the hydrophilic solvent is greater than 50 wt %, the modified microfibrillated cellulose is insufficiently dispersed and thus the modified microfibrillated cellulose may be aggregated and, consequently, precipitated.

In addition, the dispersion may further include a binder. The amount of the further included binder may be in the range of about 1 wt % to about 50 wt % with respect to a total amount of the modified microfibrillated cellulose. The binder included in the dispersion is not particularly limited and any binder used in the art may be used.

In addition, a solvent having a higher boiling point than that of water is used thanks to use of such a dispersion and thus water is first volatilized, which enables the modified microfibrillated cellulose to be dried while preventing hydrogen bonds of the cellulose. Thus, it is possible to control the average pore diameter of the separator.

In addition, in an embodiment, water may be used as the dispersion medium. Also, an organic solvent may be used and examples thereof include hydrocarbons such as hexane, benzene, toluene and the like, alcohols such as methanol, ethanol, iso-propanol, iso-butanol, sec-butanol, tert-butanol, 2-methoxy ethanol, 2-ethoxy ethanol, ethyleneglycol, glycerin, and the like, ethers such as ethyleneglycol dimethyl ether, 1,4-dioxane, tetrahydrofuran, and the like, ketones such as acetone, methyl ethyl ketone, and the like, N,N-dimethylformamide, N,N-dimethylacetamide, dimethylsulfoxide, and the like.

(Drying Process)

Next, the dispersion of the obtained modified microfibrillated cellulose is, for example, cast on a petri dish and then sufficiently dried, thereby completing fabrication of a separator for lithium ion secondary batteries which has a predetermined thickness.

The drying process may be performed using an appropriate method such as warm air drying, infrared drying, hot plate drying, vacuum drying, or the like. First, a first drying process to evaporate water by maintaining the temperature of the liquid to less than 100° C. is performed. Subsequently, after water evaporation, a second drying process to dry the hydrophilic solvent within a range of the boiling temperature of the hydrophilic solvent other than water, i.e., within a temperature range of about 100° C. to about 160° C., is performed. In this regard, by previously evaporating water, it is possible to dry the modified microfibrillated cellulose while preventing hydrogen bonds between the cellulose nanofibers. When hydrogen bonding between the cellulose nanofibers increases, the cellulose nanofibers are aggregated with one another by the hydrogen bonding and, consequently, pores are not formed in the separator.

### EXAMPLES

Hereinafter, one or more embodiments of the present invention will be described with reference to various examples. In addition, the one or more embodiments should not be construed to be limited thereby and various changes and modifications may be made based on technical goals of the one or more embodiments without departing from the scope of the one or more embodiments.

### Example 1

### Fabrication of Separator

2 g of a bleached coniferous pulp was suspended in 150 ml of water, 0.025 g of TEMPO and 0.25 g of sodium bromide were added to the suspension, and then the resulting solution was sufficiently stirred.

Next, 13 wt % of an aqueous sodium hypochlorite solution was added such that the amount of sodium hypochlorite was 1.6 mmol/g with respect to 1 g of the pulp and an oxidation reaction was initiated. In addition, during the reaction, a 0.5 N aqueous sodium hydroxide solution was added dropwise, pH was maintained to be at 10.5, and the oxidation reaction was terminated at a time when there was no change in pH.

Next, 0.5 N of hydrochloric acid was added dropwise while stirring the resulting solution until pH was stabilized to pH 1 and then filtration and washing by pure water were repeatedly performed until pH of pure water used in the washing process becomes the same as pH of the solution obtained from the washing process.

In addition, to obtain a carboxyl group content of modified cellulose fibers, 0.5 to 1 wt % of a dispersion 60 ml from a cellulose sample, the dry weight of which was accurately measured, was prepared and pH of the dispersion was adjusted to 2.5 by a 0.1 M aqueous hydrochloric acid solution. Then, a 0.05 M aqueous sodium hydroxide solution was added dropwise to the pH adjusted solution, and then electrical conductivity of the resulting solution was measured. In addition, the measurement continued until pH reached 11. In this regard, the carboxyl group content was determined using Equation 1 below from the amount of sodium hydroxide consumed in a neutralizing step of a weak acid that exhibits slow changes in electrical conductivity. The obtained results are shown in Table 1 below.

Carboxyl group content (mmol/g)=[sodium hydroxide content (ml)×0.05/cellulose weight (g)] <Equation 1>

Next, pure water and a 0.1 N aqueous lithium hydroxide solution were added to a solution including the obtained modified cellulose fibers until pH reached 10 to cause a neutralization reaction, thereby refining the modified cellulose fibers and, at the same time, preparing a 2 wt % suspension of the modified cellulose fibers.

Next, the suspension was treated using an ultra high pressure homogenizer (Sugino Machine Limited, Product name: Starburst) at 100 MPa five times, 10 mass % of dimethylformamide (boiling point: 153° C.) was added to the resulting suspension, and then the resulting solution was sufficiently stirred to obtain a microcellulose dispersion.

Subsequently, the obtained microcellulose dispersion was cast on a petri dish and dried at 100° C. for 2 hours and further at 160° C. for 2 hours, thereby completing fabrication of a separator having a thickness of 20 μm.

### Example 2

A separator having a thickness of 20 μm was manufactured using the same method as that used in Example 1 above, except that pyridine (boiling point: 115° C.) was used instead of dimethylformamide.

### Comparative Example 1

A separator having a thickness of 20 μm was manufactured using the same method as that used in Example 1 above, except that dimethylformamide was not used.

### Comparative Example 2

A separator having a thickness of 20 μm was manufactured using the same method as that used in Example 1 above, except that a 0.1 N aqueous sodium hydroxide solution was used instead of the 0.1 N aqueous lithium hydroxide solution.

### Comparative Example 3

A separator having a thickness of 20 μm was manufactured using the same method as that used in Example 1 above, except that triethylene glycol butyl methyl ether (boiling point: 261° C.) was used instead of dimethylformamide and the second drying temperature was converted to 270° C.

### Comparative Example 4

A separator having a thickness of 20 μm was manufactured using the same method as that used in Example 1 above, except that dipropylene glycol methyl ether (boiling point: 171° C.) was used instead of dimethylformamide and the second drying temperature was converted to 170° C.

### Evaluation Example 1

### Number Average Fiber Length and Measurement of Number Average Fiber Length

Each of the cellulose dispersions prepared according to Examples 1 and 2 and Comparative Examples 1 to 4 was diluted to 0.001% (concentration of the modified cellulose fibers with respect to a total solvent) with pure water and then cast on a cleaved mica substrate, the cast substrate was dried, and, thereafter, the resulting structure was observed using an atomic force microscope (AFM, manufactured by Hitachi High-Tech Science Corporation). In this regard, an average value of 20 spots was denoted as a number average fiber diameter and a number average fiber length. The obtained results are shown in Table 1 below.

### Evaluation Example 2

### Measurement of Tensile Strength

Each of the separators manufactured according to Examples 1 and 2 and Comparative Examples 1 to 4 was pulled with a strip having a width of 15 mm at a movement rate of 5 mm/min by using a tension measurement device, and stress at a maximum point was denoted as tensile strength. The obtained results are shown in Table 1 below.

### Evaluation Example 3

### Thickness Measurement

The thickness of each of the separators of Examples 1 and 2 and Comparative Examples 1 to 4 was measured by observing a cross-section of each separator by using an optical microscope (manufactured by Keyence Korea) after being cut using a razor. The obtained results are shown in Table 1 below.

### Evaluation Example 4

### Measurement of Average Pore Diameter

An average pore diameter of each of the separators of Examples 1 and 2 and Comparative Examples 1 to 4 was measured by mercury intrusion porosimetry (Micromeritics Corporation), and a median diameter was denoted as an average pore diameter. The obtained results are shown in Table 1 below.

### Evaluation Example 5

### Performance Evaluation of Lithium Ion Secondary Battery

A lithium ion secondary battery was manufactured using each of the separators of Examples 1 and 2 and Comparative Examples 1 to 4, a positive electrode fabricated using LiCoO₂, a negative electrode fabricated using graphite, and an electrolytic solution obtained by dissolving 1 mol/L of LiPF₆ in a mixture of ethylene carbonate (EC) and diethyl carbonate (DEC) at a volume ratio of 3:7. In addition, each lithium ion secondary battery was charged with 0.1 C to 4.2 V and battery characteristics thereof were compared with one another. In addition, the battery characteristics were evaluated by the following standards.

∘ . . . when being charged to 4.2 V, satisfactory battery characteristics

x . . . when not being charged to 4.2 V, poor battery characteristics

### Evaluation Example 6

### Measurement of Metal Ion Content

A metal ion content of each of the separators of Examples 1 and 2 and Comparative Examples 1 to 4 was measured as follows: the amount of a metal except for Li was measured using an electron probe microanalyzer (EPMA method, manufactured by JEOL). The obtained results are shown in Table 1 below.

| | Example | Example | Comparative | Comparative | Comparative | Comparative |
|---|---|---|---|---|---|---|
| | 1 | 2 | Example 1 | Example 2 | Example 3 | Example 4 |
| Counter ion | Li | Li | Li | Na | Li | Li |
| Amount of metal | 8 | 8 | 8 | 100 | 8 | 8 |
| ion except for | | | | | | |
| lithium ion [wt %] | | | | | | |
| Average pore | 0.4 | 0.2 | 0.01 or less | 0.3 | Impossible | 0.6 |
| diameter [μm] | | | | | to measure | |
| Carboxyl group | 1.6 | 1.6 | 1.6 | 1.6 | 1.6 | 1.6 |
| content [mmol/g] | | | | | | |
| Number average | 0.8 | 0.8 | 0.7 | 0.8 | 0.8 | 0.8 |
| fiber length [μm] | | | | | | |
| Number average | 3.5 | 3.4 | 3.6 | 3.5 | 3.5 | 3.5 |
| fiber diameter | | | | | | |
| [nm] | | | | | | |
| Boiling point of | 153 | 115 | — | 153 | 261 | 171 |
| hydrophilic | | | | | | |
| solvent [° C.] | | | | | | |
| Second drying | 160 | 160 | 160 | 160 | 270 | 170 |
| temperature [° C.] | | | | | | |
| Tensile strength | 110 | 100 | 140 | 100 | Impossible | 50 |
| [MPa] | | | | | to measure | |
| Battery | ∘ | ∘ | x | x | Impossible | x |
| characteristics | | | | | to measure | |

As shown in Table 1 above, it is confirmed that the lithium ion secondary batteries of Examples 1 and 2 exhibit superior battery characteristics to those of the lithium ion secondary batteries of Comparative Examples 1 to 4.

That is, this is attributed to counter ions of carboxyl groups being lithium ions, the weight of ions except for the lithium ions, in the counter ions, being 10 wt % or less with respect to a total amount of the lithium ions, and an average pore diameter being in the range of about 0.05 μm to about 1 μm. Thus, as described above, satisfactory battery performance may be achieved without hindrance of transfer of lithium ions between electrodes.

As is apparent from the foregoing description, according to an embodiment of the present disclosure, satisfactory battery performance may be achieved by using the separator for lithium batteries described above without hindrance of transfer of lithium ions between electrodes.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A separator sheet for a lithium battery comprising modified microfibrillated cellulose, wherein the microfibrillated cellulose comprises surface carboxyl groups
and counter ions of the carboxyl groups that comprise lithium ions,
wherein the counter ions comprise 10 wt % or less metal ions other than lithium with respect to a total weight of the lithium ions, and
wherein the separator has an average pore diameter of about 0.05 μm to about 1 μm.

2. The separator of claim 1, wherein the modified microfibrillated cellulose has a cellulose I-type crystal structure.

3. The separator of claim 1, wherein a surface carboxyl group content of the modified microfibrillated cellulose is about 0.1 mmol/g to about 2.5 mmol/g.

4. The separator of claim 1, wherein the modified microfibrillated cellulose has a number average fiber length of about 0.2 μm to about 3 μm.

5. The separator of claim 1, wherein the modified microfibrillated cellulose has a number average fiber diameter of 100 nm or less.

6. The separator of claim 1, wherein the separator has a tensile strength of about 100 MPa to about 140 MPa.

7. A lithium battery comprising:
a positive electrode;
a negative electrode; and
the separator according to claim 1 disposed between the positive electrode and the negative electrode.

8. The lithium battery of claim 7, wherein the lithium battery is a lithium ion battery.

9. The lithium battery of claim 7, wherein the lithium battery is a lithium air battery.

10. A method of manufacturing a separator for a lithium battery, the method comprising:
preparing a solution comprising modified microfibrillated cellulose with carboxyl groups on a surface thereof, a hydrophilic solvent having a boiling point of about 100 to about 160° C., and water;
coating the solution on a substrate;
drying the solution coated on the substrate to prepare a film; and
separating the film from the substrate.

11. The method of claim 10, wherein the drying comprises:
a first drying process to perform drying at less than 100° C.; and
a second drying process to perform drying at a temperature between about 100° C. and about 160° C.

12. The method of claim 10, wherein the solution comprises about 1 wt % to about 50 wt % of the hydrophilic solvent with respect to a total amount of the solution.

13. The method of claim 10, wherein the hydrophilic solvent comprises at least one selected from dimethylformamide and pyridine.

14. The method of claim 10, wherein the solution comprises about 0.1 wt % to about 10 wt % modified microfibrillated cellulose with respect to a total amount of the solution.

15. The method of claim 10, wherein the solution further comprises about 1 wt % to about 50 wt % of a binder with respect to a total amount of the modified microfibrillated cellulose.

16. The method of claim 10, wherein the microfibrillated cellulose comprises counter ions of the carboxyl groups, and the counterions comprise lithium ions,
wherein the counter ions comprise 10 wt % or less metal ions other than lithium with respect to a total weight of the lithium ions.

17. The method of claim 10, wherein the modified microfibrillated cellulose has a cellulose I-type crystal structure.

18. The method of claim 10, wherein an amount of the carboxyl groups in the modified microfibrillated cellulose is between about 0.1 mmol/g and about 2.5 mmol/g.

19. The method of claim 10, wherein the modified microfibrillated cellulose has a number average fiber length of about 0.2 μm to about 3 μm.

20. The method of claim 10, wherein the modified microfibrillated cellulose has a number average fiber diameter of 100 nm or less.
